(19) United States
(12) Patent Application Publication
(10) Pub. No.: US 2014/0055614 A1
(43) Pub. Date: Feb. 27, 2014

(54) Vehicular Pedestrian Sensor Apparatus

(71) Applicant: David J. Kahan, Malvern (AU)

(72) Inventor: David J. Kahan, Malvern (AU)

(21) Appl. No.: 13/590,785

(22) Filed: Aug. 21, 2012

(51) Int. Cl. B60Q 1/00; H04N 7/18

(52) U.S. Cl. 348/148; 340/435; 348/E07.085

(57) ABSTRACT

A vehicular pedestrian sensor apparatus including a vehicular sensor disposed within an automobile, the vehicle sensor in wireless communication with at least one sensor disposed exteriorly relative to the automobile, the at least one sensor sensible of motion within a field of view, wherein the at least one sensor activates a first alarm signal, said first alarm signal displayed by the vehicular sensor, and a second alarm signal, said second alarm signal displayed by the at least one sensor, whereby a driver is notified of motion of an object within the field of view, and the at least one sensor displays an alarm sensible to a person proximal to the field of view.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Various types of vehicular pedestrian sensor apparatuses are known in the prior art. However, what is needed is a vehicular pedestrian sensor apparatus that includes a vehicular sensor disposed within an automobile, the vehicle sensor in wireless communication with at least one sensor disposed exteriorly relative said automobile, the at least one sensor sensible of motion within a field of view, wherein the at least one sensor activates a first alarm signal, said first alarm signal displayed by the vehicular sensor, and a second alarm signal, said second alarm signal displayed by the at least one sensor, whereby a driver is notified of motion of an object within the field of view, and the at least one sensor displays an alarm sensible to a person proximal to the field of view.

### FIELD OF THE INVENTION

The present invention relates to a vehicular pedestrian sensor apparatus, and more particularly, to a vehicular pedestrian sensor apparatus including a vehicular sensor disposed within an automobile, the vehicle sensor in wireless communication with at least one sensor disposed exteriorly relative to the automobile, the at least one sensor sensible of motion within a field of view, wherein the at least one sensor activates a first alarm signal, said first alarm signal displayed by the vehicular sensor, and a second alarm signal, said second alarm signal displayed by the at least one sensor, whereby a driver is notified of motion of an object within the field of view, and the at least one sensor displays an alarm sensible to a person proximal to the field of view.

### SUMMARY OF THE INVENTION

The general purpose of the vehicular pedestrian sensor apparatus, described subsequently in greater detail, is to provide a vehicular pedestrian sensor apparatus which has many novel features that result in a vehicular pedestrian sensor apparatus which is not anticipated, rendered obvious, suggested, or even implied by prior art, either alone or in combination thereof.

The present vehicular pedestrian sensor apparatus has been devised to increase safety around driveways where vehicular traffic emerging onto a thoroughfare can cause accidents with pedestrians walking nearby. Many people reverse their automobiles from their driveways when leaving the home, and visibility is often impaired around paths and sidewalks proximal to the driveway entrance. Moreover, many drivers are in a hurry and, while checking for oncoming traffic in the thoroughfare, nevertheless neglect to adequately maintain a line of sight with pedestrian traffic walking, or cycling, on the sidewalk proximal to said driveway entrance. The present vehicular pedestrian sensor apparatus, therefore, has been devised to alert a driver to an object moving with a field of view encompassing the driveway entrance and the immediate surrounding area, to avoid collision with pedestrians walking therein. At the same time, the present vehicular pedestrian sensor apparatus has been devised to alert said pedestrians to the approach of an automobile moving down the driveway proximal to said field of view.

The present vehicular pedestrian sensor apparatus, therefore, includes a vehicular sensor, disposed within the interior of an automobile, in wireless communication with at least one sensor disposed exteriorly relative said automobile. The at least one sensor is envisioned to be mounted proximal to a driveway entrance, for example on a driveway gate, or upon pillars or posts that demark the driveway entrance.

The vehicular sensor includes a housing removably attachable to an automobile interior. An illuminating device is disposed on the housing, a sonic device is disposed within the housing, an accelerometer is disposed within the housing, and a central processing unit (CPU) is disposed within the housing, the CPU in operational communication with the illuminating device, the sonic device, the wireless interface, and the accelerometer. When the automobile is accelerated, the CPU activates the vehicular pedestrian sensor apparatus; the vehicular sensor is in wireless communication with the at least one sensor disposed exteriorly relative the automobile.

The at least one sensor includes a second housing removably mountable to an external surface, such as a driveway gate, pillar, or post demarking the driveway entrance. A second illuminating device is disposed upon the second housing, a second sonic device is disposed within the second housing, a second wireless interface is disposed within the second housing, a motion detector is disposed within the second housing, and a second CPU is disposed within the second housing, the second CPU in operational communication with the second illuminating device, the second sonic device, the motion detector, the second wireless interface, and the vehicular sensor. The motion detector is configured to be sensible of a field of view encompassing the driveway entrance and the immediate surrounding area.

When the automobile is set in motion, the CPU activates the wireless interface to initiate the vehicular pedestrian sensor apparatus, and the at least one sensor is in operational communication with the vehicular sensor. When an object is detected moving within the field of view by the motion detector, the second CPU activates a first alarm signal and a second alarm signal simultaneously. The first alarm signal is communicated to the vehicular sensor, and the CPU activates the illuminating device and the sonic device to alert the driver of an object moving within the field of view. The illuminating device displays a visible signal and the sonic device emits an audible signal. The driver, thusly alerted, is enabled to take corrective action to avoid collision with the object detected in the field of view.

The second alarm signal is displayed by the at least one sensor disposed exteriorly relative the automobile, and is devised to be sensible to a person proximal the field of view. When activating the second alarm signal, the second CPU activates the second illuminating device to display a visible signal to a person proximal the field of view and also the second sonic device to emit an audible signal to a person proximal the field of view. Said person proximal the field of view is thereby alerted to the movement of the automobile approaching the field of view, and said person is enabled to take corrective action to avoid a potential collision with said vehicle.

In the preferred embodiment herein disclosed, the at least one sensor includes a sensor cover removably attachable to a mounting plate, said mounting plate configured to be removably mountable to a structure. The sensor cover includes an aperture through which the motion detector captures the field of view. When attached to the mounting plate, the sensor cover sealingly encloses an interior cavity wherein the second sonic device, the second wireless interface, the second CPU, and the motion detector are enclosed. The at least one sensor includes a gasket and a polymeric layer to sealingly enclose the interior cavity and weatherize the at lest one sensor for use outside.

To power the at least one sensor, a plurality of batteries are included, each of the plurality of batteries removably interchangeable, as desired, when the sensor cover is removed from the mounting plate. In the preferred embodiment herein disclosed, each of the plurality of batteries is envisioned to be a typical cell battery, for example an AA battery. However, the device should not be considered limited by the type and number of the plurality of batteries. The second alarm signal as displayed by the at least one sensor is considered to be louder and brighter than the first alarm signal as displayed by the vehicular sensor, to alert a person proximal the field of view.

In the preferred embodiment disclosed in this specification, the vehicular sensor includes an upper housing removably attachable to a lower housing. A battery door is slidably disposed in the upper housing to enable access to a central space wherein a battery is removably insertable to power the vehicular sensor. In the preferred embodiment disclosed herein, the battery is envisioned to be a button cell. The vehicular sensor is envisioned to use less power than the at least one sensor because the display of the first alarm signal, rendered within the interior of an automobile, is considered to be less bright and less loud in order to alert a driver of said automobile of an object detected within the field of view. To readily install the vehicular sensor to an automobile interior, an adhesive backing is disposed on the lower housing. The vehicular sensor is readily mounted to an automobile interior by means of the adhesive backing.

It should be noted that the first alarm signal and the second alarm signal are only activatable when the vehicular sensor detects motion of the automobile in which said vehicular sensor is mounted, by means of the accelerometer, and when an object is detected moving within the field of view by means of the motion detector disposed in the at least one sensor. In the preferred embodiment herein disclosed, the motion detector is envisioned to be a camera and alternately a passive infrared sensor. Therefore, when the automobile in which the vehicular sensor is mounted is stationary, objects moving within the field of view will not cause the first and second alarm signals to be activated.

Moreover, the vehicular sensor and the at least one sensor are in wireless communication with each other. When the automobile in which the vehicular sensor is mounted enters the field of view, the first and second alarm signals are not triggered by the motion of the automobile itself.

Thus has been broadly outlined the more important features of the present vehicular pedestrian sensor apparatus so that the detailed description thereof that follows may be better understood and in order that the present contribution to the art may be better appreciated.

Objects of the present vehicular pedestrian sensor apparatus, along with various novel features that characterize the invention are particularly pointed out in the claims forming a part of this disclosure. For better understanding of the vehicular pedestrian sensor apparatus, its operating advantages and specific objects attained by its uses, refer to the accompanying drawings and description.

### BRIEF DESCRIPTION OF THE DRAWINGS

### Figures

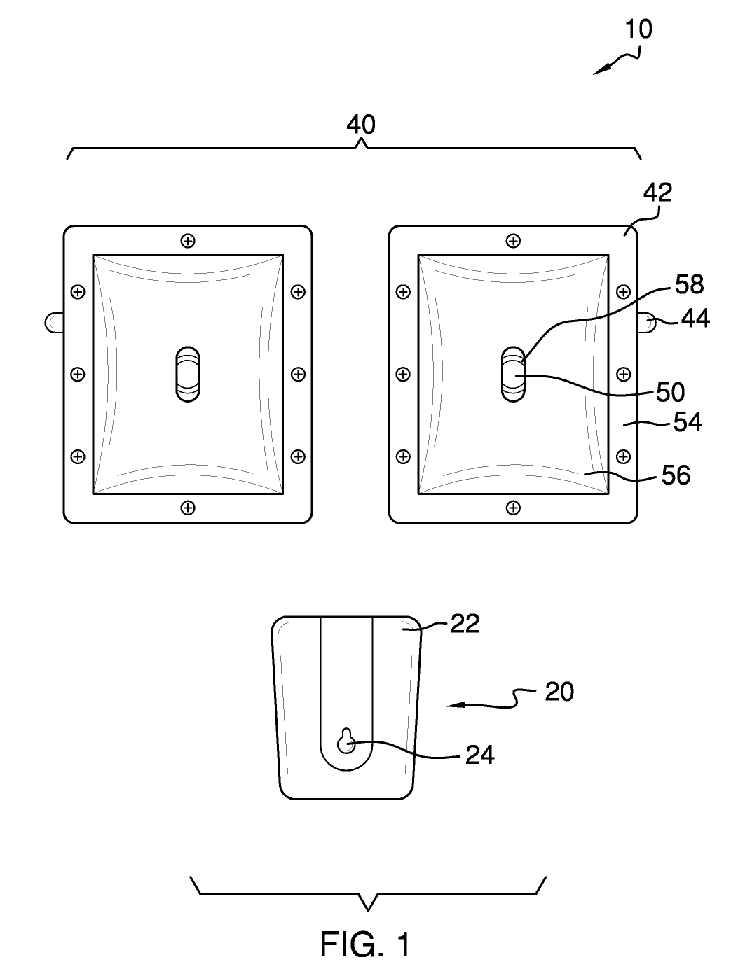

FIG. 1 is a front view.

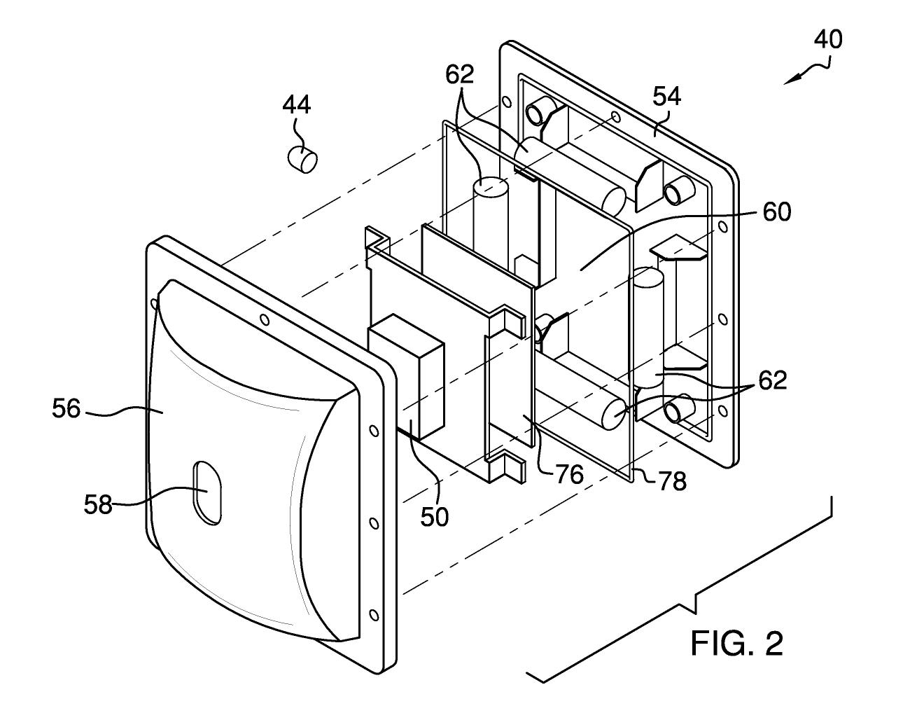

FIG. 2 is an exploded view of at least one sensor.

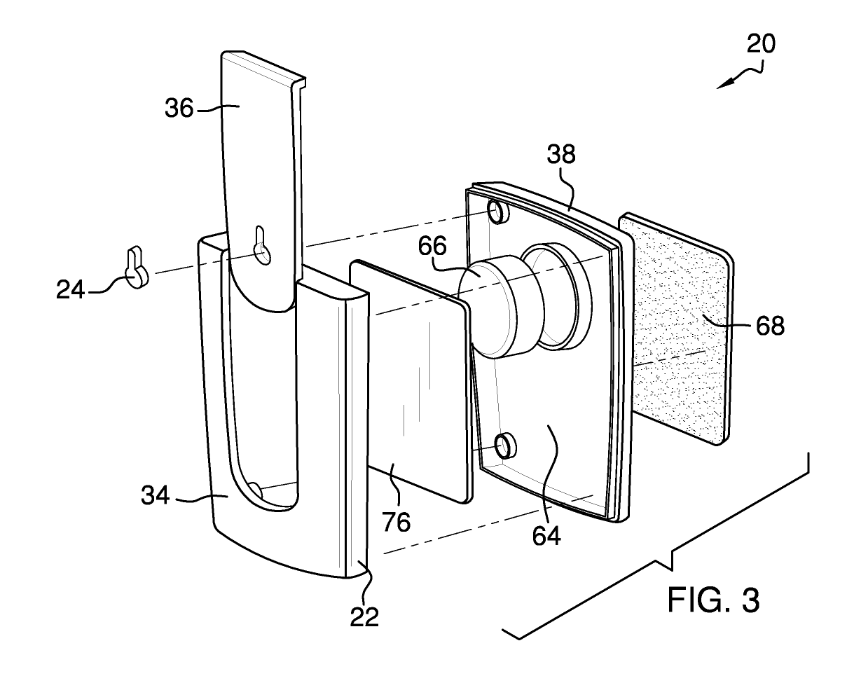

FIG. 3 is an exploded view of a vehicular sensor.

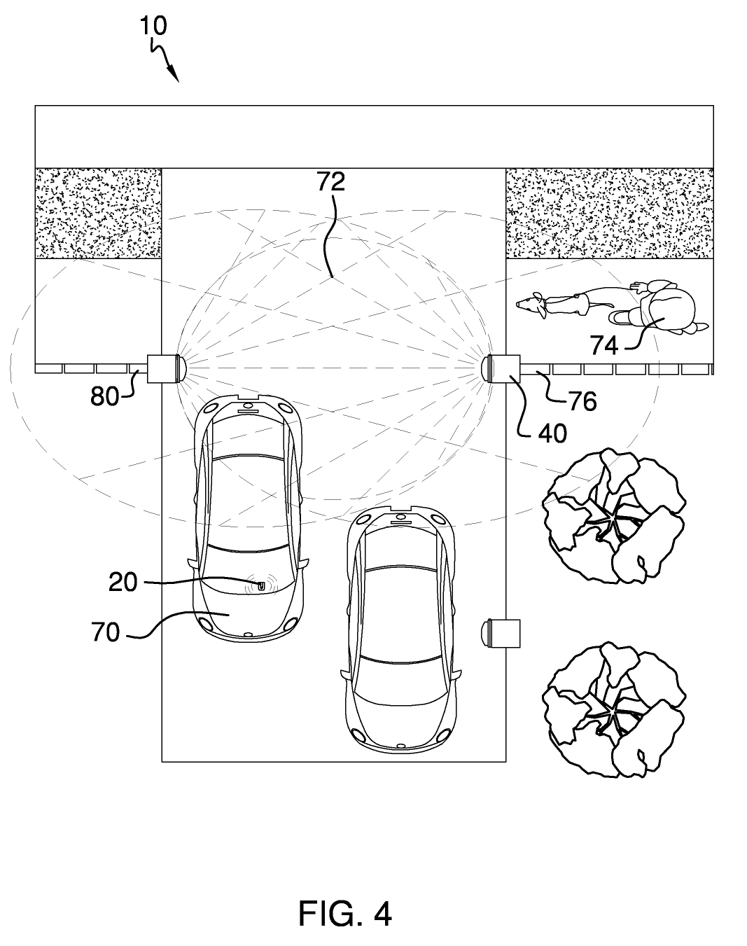

FIG. 4 is an in-use view.

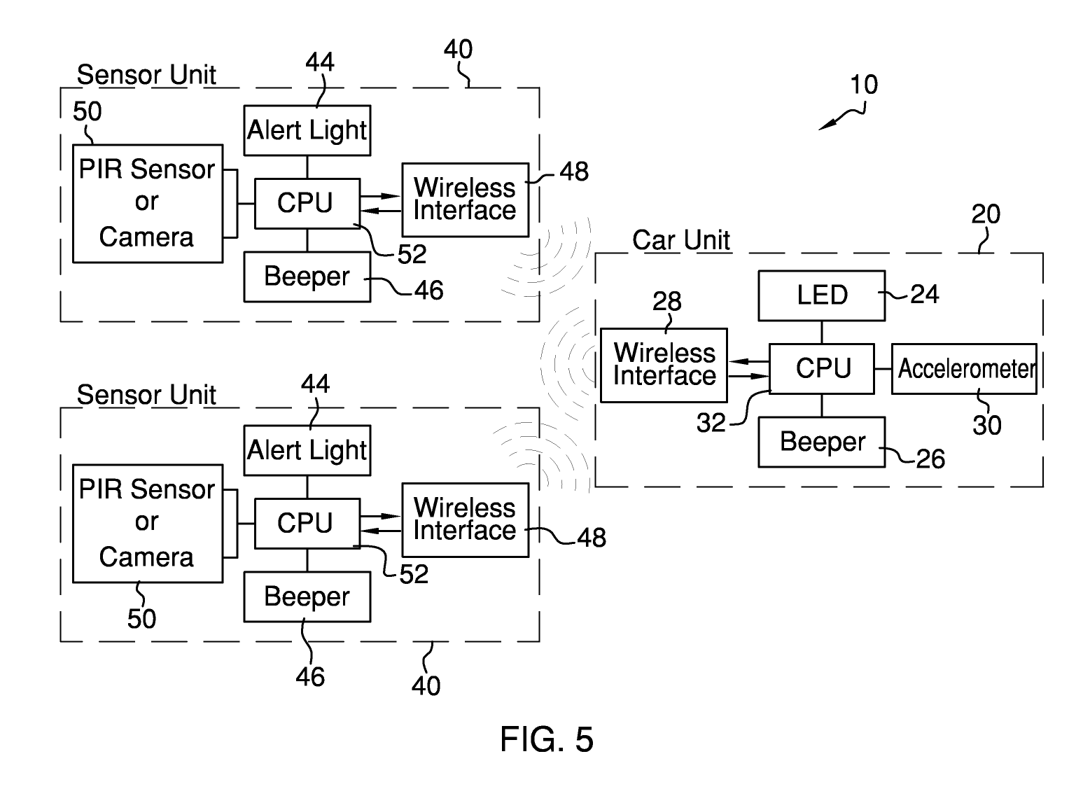

FIG. 5 is a schematic view.

### DETAILED DESCRIPTION OF THE DRAWINGS

With reference now to the drawings, and in particular FIGS. 1 through 5 thereof, example of the instant vehicular pedestrian sensor apparatus employing the principles and concepts of the present vehicular pedestrian sensor apparatus and generally designated by the reference number 10 will be described.

Referring to FIGS. 1 through 5 a preferred embodiment of the present vehicular pedestrian sensor apparatus 10 is illustrated.

The vehicular pedestrian sensor apparatus 10 includes a vehicular sensor 20 disposed within an automobile 70 and at least one sensor 40 disposed exteriorly relative the automobile 70. The vehicular sensor 20 is in wireless communication with the at least one sensor 40 disposed exteriorly relative to the automobile 70. The at least one sensor 40 is sensible of motion within a field of view 72 wherein the at least one sensor 40 activates a first alarm signal, said first alarm signal displayed by the vehicular sensor 20, and a second alarm signal, said second alarm signal displayed by the at least one sensor 40, whereby a driver within the automobile 70 is notified of the motion of an object within the field of view 72, and the at least one sensor 40 displays the second alarm signal sensible to a person 74 proximal to the field of view 72.

The vehicular sensor 20 includes a housing 22, an illuminating device 24 disposed upon the housing 22, a sonic device 26 disposed within the housing 22, a wireless interface 28 disposed within the housing 22, an accelerometer 30 disposed within the housing 22, and a CPU 32 disposed within the housing 22.

The at least one sensor 40 is in operational wireless communication with the vehicular sensor 20 and includes a second housing 42, a second illuminating device 44 disposed upon the second housing 42, a second sonic device 46 disposed within the second housing 42, a second wireless interface 48 disposed within the second housing 42, a motion detector 50 disposed within the second housing 42, and a second CPU 52 disposed within the second housing 42.

The CPU 32 activates the vehicular pedestrian sensor apparatus 10 when detecting motion of the automobile 70 by means of the accelerometer 30. The vehicular pedestrian sensor apparatus 10 is then initiated. Motion of an object within the field of view 72 is thereby detectible by the motion sensor 50 disposed in the second housing 42 of the at least one sensor 40. When the present vehicular pedestrian sensor apparatus 10 is initiated and motion of an object within the field of view 72 is detected by the motion sensor 50, the second CPU 52 activates the first alarm signal and the second alarm signal simultaneously. The second wireless interface 48 is then activated to operationally communicate with the vehicular sensor 20, whereby the first alarm signal is activated and displayed by the vehicular sensor 20. The CPU 30 activates the illuminating device 24, to produce a visible signal, and the sonic device 26, to produce an audible signal, and a driver of the automobile 70 is notified of an object moving within the field of view 72 by means of visible and audible signals. The driver is thereby enabled to take corrective action to avoid collision with the object sensed within the field of view 72.

Simultaneously, the second CPU 52 activates the second alarm signal. The second alarm signal is displayed by the at least one sensor 40, and the second CPU 52 activates the second illuminating device 44 and the second sonic device 46 to produce respectively a visible signal and an audible signal whereby a person 74 proximal to the field of view 72 is notified of the motion of the automobile 70 proximal to the field of view 72. Said person 74 proximal to the field of view 72 can then take appropriate action to avoid collision with the automobile 70.

In the preferred embodiment disclosed in this specification, the motion detector 50 is envisioned to include a camera and alternately a passive infrared sensor. The preferred embodiment is illustrated with the at least one sensor 40 including two such sensors as previously described, disposed on either side of a driveway wherefrom an automobile 70 is emerging (see FIG. 4).

Referring now to FIG. 2, the at least one sensor 40 includes a mounting plate 54, and the second housing 42 is thereby removably mountable to an object, such as driveway gate 80 (as illustrated in FIG. 4). The second housing 42 includes a removably attachable sensor cover 56 having an aperture 58 disposed therein, through which aperture the motion detector 50 captures the field of view 72. An interior cavity 60 is disposed within the second housing 42 to securely house the second CPU 52, the second wireless interface 48, the second sonic device 46, and the circuitry required to operationally communicate with the second CPU 52. A plurality of batteries 62 are included to power the at least one sensor 40. Each of the plurality of batteries 62 may be interchanged, as needed, by removing the sensor cover 56. A polymeric member 76 is included and a gasket 78 to weatherize the at least one sensor 40 for use outside.

In the preferred embodiment herein disclosed, now referring to FIG. 3, the vehicular sensor 20 housing 22 includes an upper housing 34 having a battery door 36 slidably disposed therein. The upper housing 34 is removably attachable to a lower housing 38 to enclose a central space 64 wherein a battery 66 is replaceable and the sonic device 26, the wireless interface 28, the accelerometer 30, and the CPU 32, are housed. An adhesive backing 68 is disposed on the lower housing 38 whereby the vehicular sensor 20 is removably mountable to the interior of an automobile 70, as desired.

The present invention is therefore envisioned to increase the safety of traffic emerging onto thoroughfares, to lessen automobile accidents with pedestrians especially when said automobile 70 is reversing from a driveway, as is common in the present age.

What is claimed is:

1. A vehicular pedestrian sensor apparatus comprising a vehicular sensor disposed within an automobile, the vehicular sensor in wireless communication with at least one sensor disposed exteriorly relative to the automobile, the at least one sensor sensible of motion within a field of view, wherein the at least one sensor activates a first alarm signal, said first alarm signal displayed by the vehicular sensor, and a second alarm signal, said second alarm signal displayed by the at least one sensor, whereby a driver within the automobile is notified of motion of an object within the field of view, and the at least one sensor displays the second alarm signal sensible to a person proximal to the field of view.

2. The vehicular pedestrian sensor apparatus of claim 1 wherein the vehicular sensor comprises:
a housing;
an illuminating device disposed upon the housing, the illuminating device activatable when the first alarm signal is activated by the detection of motion proximal to the field of view;
a sonic device activatable when the first alarm signal is activated;
a wireless interface in operational communication with the at least one sensor;
a CPU in operational communication with the illuminating device, the sonic device, and the wireless interface;
wherein motion detected within the field of view activates the first alarm and the second alarm only when the automobile is moving.

3. The vehicular pedestrian sensor apparatus of claim 2 wherein the at least one sensor comprises:
a second housing;
a second illuminating device disposed upon the second housing, said second illuminating device activatable when the first alarm signal is activated by the detection of motion of an object within the field of view;
a second sonic device, said second sonic device activatable when the first alarm signal is activated;
a motion detector sensible of the field of view;
a second CPU in operational communication with the second illuminating device, the second sonic device, and the second motion detector;
a second wireless interface in operational communication with the CPU and the wireless interface of the vehicular sensor;
wherein the motion detector signals motion detected within the field of view to the second CPU and the second CPU operationally engages the second illuminating device and the second sonic device to display the second alarm signal and the wireless interface operationally communicates with the vehicular sensor to display the first alarm signal.

4. The vehicular pedestrian sensor apparatus of claim 3 wherein the vehicular sensor further comprises an accelerometer in operational communication with the CPU, whereby the vehicular sensor and the at least one sensor are activated only when motion of the automobile is detected by the accelerometer and the vehicular pedestrian sensor apparatus is thereby initiated to activate the first and second alarm signals when motion of an object is detected within the field of view.

5. The vehicular pedestrian sensor apparatus of claim 4 wherein the motion detector comprises a passive infrared sensor.

6. The vehicular pedestrian sensor apparatus of claim 4 wherein the motion detector comprises a camera.

7. The vehicular pedestrian sensor apparatus of claim 4 wherein the first alarm signal activates the illuminating device and the sonic device to produce respectively visible and audible signals whereby a driver of the automobile is alerted to the presence of motion of an object within the field of view.

8. The vehicular pedestrian sensor apparatus of claim 7 wherein the second alarm signal activates the second illuminating device and the second sonic device to produce respectively visible and audible signals whereby a person proximal to the field of view is alerted of the motion of the automobile.

9. The vehicular pedestrian sensor apparatus of claim 8 wherein the at least one sensor and the vehicular sensor wirelessly communicate to be sensible of the position of the automobile relative the at least one sensor whereby the first and second alarm signals are not activated by the motion of the automobile entering the field of view.

10. A vehicular pedestrian sensor apparatus comprising:
a vehicular sensor disposed within an automobile, the vehicular sensor comprising a housing, an illuminating device disposed upon the housing, a sonic device disposed within the housing, a wireless interface disposed within the housing, an accelerometer disposed within the housing, and a CPU disposed within the housing;
at least one sensor mounted exteriorly relative the automobile, the at least one sensor in operational wireless communication with the vehicular sensor, the at least one sensor comprising a second housing, a second illuminating device disposed upon the second housing, a second sonic device disposed within the second housing, a second wireless interface disposed within the second housing, a motion detector disposed within the housing, and a second CPU disposed within the housing;
wherein the CPU activates the vehicular pedestrian sensor apparatus when detecting motion of the automobile and the second CPU activates a first alarm signal, displayed by the vehicular sensor, and a second alarm signal, displayed by the at least one sensor, when motion is detected within a field of view sensible to the at least one sensor.
